(19) United States
(12) Patent Application Publication
(10) Pub. No.: US 2021/0039084 A1
(43) Pub. Date: Feb. 11, 2021

(54) Device for dispensing liquid product with enhanced efficiency

(71) Applicant: TECHNIPLAST, LOUVIERS (FR)

(72) Inventor: Jean-Philippe LAMBOUX, Saint Didier des Bois (FR)

(21) Appl. No.: 16/986,511

(22) Filed: Aug. 6, 2020

(30) Foreign Application Priority Data
Aug. 9, 2019 (EP) 19 191 011.6

(51) Int. Cl. B01L 3/02

(52) U.S. Cl. CPC B01L 3/0272; B01L 2400/0481

(57) ABSTRACT

A device for dispensing drops of a liquid or semi-liquid product is provided having an axial tube (12) which has an elastically deformable outer jacket defining an internal space (16) enclosing the product and a neck (14) which defines an open internal passage for the passage of the product. A system for generating drops has an elastic deformable piece (22) mounted inside the neck of the tube around a rigid member (24). The elastically deformable piece has an opening end part (30b) situated outside of the neck and through which the product can exit from the system in case of pressure on the outer jacket. The opening end part (30b) is deformed into a first position when it is mounted to bear on an opening end (36) of the rigid member when no pressure is exerted on the jacket of the tube.

### RELATED APPLICATION

This application claims the benefit of priority from European Patent Application No. 19 191 011.6, filed on Aug. 9, 2019, the entirety of which is incorporated by reference.

### FIELD OF THE INVENTION

The invention relates to a device for dispensing a liquid or semi-liquid product in the form of drops.

### DESCRIPTION OF THE RELATED ART

The currently known devices for generating drops of product are encountered for example in the field of ophthalmic products and are divided into two categories.

In the first category there are the single-dose devices whose container, made of flexible plastic (the containers are generally manufactured and offered for sale in the form of a package enclosing a strip of containers fixed to one another in such a way as to be able to be detached by a user), is sealed by a stopper which has to be irreversibly detached before any use. The user presses strongly on the outer jacket of the container in order to extract the liquid product in the form of drops through the non-resealable orifice. This type of device is designed to deliver a single dose of product (daily dose formed by one or more drops) and when the user has extracted the prescribed dose from the container, even if there is still product remaining therein, the orifice cannot be resealed and therefore the product can deteriorate on contact with the air. The cost of the prescribed dose is therefore relatively high since it requires one container per dose.

In the second category there are the devices which take the form of a flask containing several doses for a complete treatment over several days. However, the product contained in the flask is in contact with the ambient air each time the flask is opened and it is therefore exposed to the various pollutions conveyed by the air. This means that the manufacturers are obliged to add conserving agents to the product such as anti-bacterial agents, antioxidants, and the like. However, such agents can generate reactions with the eyes of the users.

Given the above, there is therefore a need for a novel device for dispensing drops of a liquid or semi-liquid product which remedies at least one of the abovementioned drawbacks, notably which limits the pollution of the device, and can have numerous applications notably including the ophthalmic domain.

The document US 2013/0037574 discloses a device for dispensing drops of liquid product in the form of doses but which is not however satisfactory.

Also known from the documents U.S. Pat. No. 5,271,513, FR 747 465 and FR 3 041 411 are devices for dispensing fluid with an elastically deformable lip mounted to bear on a needle valve.

### OBJECTS AND SUMMARY

The subject of the present invention is thus a device for dispensing drops of a liquid or semi-liquid product, characterized in that it comprises:
an axial tube which comprises an elastically deformable outer jacket defining an internal space enclosing the product,
a neck-forming part which defines an open internal passage for the passage of the product,
a system for generating drops which is disposed at the neck and which can, on the one hand, form and expel a drop of product from the system following a pressure exerted on the outer jacket tending to deform it and to reduce the volume of the internal space and, on the other hand, prevent or limit the return of product into the system when the pressure on the jacket ceases, the drop generating system comprising an elastically deformable piece mounted inside the neck of the tube around a rigid member, the elastically deformable piece comprising an opening end part situated outside of the neck and through which the product can exit from the system in case of pressure on the outer jacket, the opening end part of the elastically deformable piece being formed in a first position following the penetration of an opening end of the rigid member into said opening end part when no pressure is exerted on the jacket of the tube, the rigid member also comprising a portion which exerts an axial strain on a zone Z of the elastically deformable piece situated at a distance from the opening end of said piece so as to define a pivot point for the opening end part of said piece which is situated between this zone Z and the opening end of said piece.

The elastically deformable piece is strained when it is mounted inside the neck around the rigid member, the latter forcing the opening end part of the piece to be deformed according to a first deformed position, in the absence of pressure exerted on the jacket. This first strain is exerted by the opening end (generally central) of the rigid member which pushes back the deformable opening end part in the inside by forcing it to be deformed outwards.

The opening end part thus rests deformed bearing on (and around) the opening end of the rigid member which exerts on the latter a radial and axial thrust effort. The contact between the opening end part and the opening end of the rigid member is therefore tight, which makes it possible to ensure the seal (with respect to a possible return of product into the system) between these two elements in the absence of pressure on the outer jacket of the tube.

The axial strain (parallel to the axis of the tube) exerted by the portion of rigid member (portion called straining portion) in the internal zone Z of the elastically deformable piece (creation or not of a mechanical interference on the internal face of the piece and towards the outside thereof) corresponds to an axial thrust effort generated on the internal face of the piece in said zone Z and creating a local deformation. This local axial straining of the piece makes it possible to define, and generally to block, a pivot point for a part of this piece and thus control the geometry of opening and of reclosing of the opening end part which is situated between this zone Z and the opening end (free) of the elastically deformable piece. This local axial strain thus makes it possible to prioritize a mechanical deformation for just a part of the elastically deformable piece (the part of the piece which will be deformed as a priority is circumscribed on the part of said piece which extends between the strained zone Z and the opening end (free) of the piece) and control it by prioritizing/favouring also the orientation of the deformation itself (primarily radial controlled elastic deformation). In fact, this axial straining of the zone Z favours an opening movement of the opening end part that is radial outwards (under the action of an external pressure exerted on the tube to dispense product through the drop generating system): the opening end part is thus deformed by separating mostly radially (relative to the axis of the tube) from the opening end of the rigid member against which it bears rather than axially as in the prior art (generally, in the prior art, the deformation of the elastically deformable piece is free, random and uncontrolled). The control of the deformation of the opening end part according to a movement or displacement that is primarily/mostly radial is due to the axial straining of the zone Z of the elastically deformable piece (pivot point defined following the local axial strain exerted by a portion of the rigid member on the elastically deformable piece). Likewise, upon reclosure, that is to say when the external action exerted by a user on the tube ceases, the opening end part of the piece reverts to its initial position by being deformed mostly radially towards the opening end of the rigid member to approach it and come to bear thereon. This essentially radial controlled elastic deformation makes it possible to greatly limit, even avoid, the phenomenon of product uptake when the dispensing action ceases (uptake of the product extracted from the device and which still adheres to the opening end of the drop generating system).

The axial strain exerted by the portion of rigid member on the zone Z of the elastically deformable piece (on the internal side of this piece or on its internal face) can be seen as a strain of axial pressure exerted on this zone. This strain leads to the deformation of the constituent material of the elastically deformable piece. Depending on the value of the strain and the nature of the material itself, the deformation can take different forms: the straining portion of the rigid member (this is the portion which is configured to exert this local axial strain on the piece) can for example penetrate into the internal face of the piece or exert a local pressure thereon without penetrating it and, in this case, the material of the piece can be deformed by stretching of the material and for example other than in the zone Z. It will be noted that this strain (and the associated deformation) is permanent when the elastically deformable piece is mounted around the rigid member inside the neck of the tube.

The straining of the elastically deformable piece by an appropriately adapted/configured portion of the rigid member (and on which the piece bears) defines the opening end part of the piece which will be deformed, which thus makes it possible to control the length of this zone or part of deformation. By adjusting, in design, the length of this zone or part of deformation, it is possible to adjust the pressure effort to be exerted on the outer jacket of the tube to dispense a drop of product. As an example, the greater the length of this zone or part of deformation, the weaker the pressure effort on the jacket of the tube.

The axial straining of the elastically deformable piece by the portion of rigid member in the zone Z of the piece takes place in addition to the straining exerted by the opening end of the rigid member on said opening end part of the piece, as explained above.

It will be noted that the straining portion of the rigid member is distinct from the opening end, generally central, thereof.

The axial tube has a generally longitudinal form which thus defines the axis of the tube and the axis along which the product flows between the elastically deformable piece and the opening end of the rigid member to exit from the device.

In the device briefly described above, the opening end part of the elastically deformable piece is generally pierced with an opening or an orifice at its opening end for the passage of the rigid member and to come to bear against the opening end of this rigid member in rest position (when no pressure is exerted by the user on the jacket of the tube). On the other hand, if a pressure is exerted by the user on the jacket of the tube, the product under pressure flows towards the outlet of the drop generating system and thus spreads radially and away from the rigid member the opening end part of the rigid member to flow between these two elements out of the device. Generally, the opening end part surrounds the opening end of the rigid member and generally has an axial symmetry.

According to other possible features:
the opening end of the rigid member has an outer diameter greater than the output diameter of the opening end part, in the absence of deformation, in order for the opening end of said rigid member to radially deform the opening end part when the latter is mounted to bear on the opening end of the rigid member; it will be noted that the opening end part which has thus been strained on mounting is of the type to be deformed radially to adopt a second deformed position which allows the passage of a drop of product in the case of pressure exerted on the jacket; upon radial deformation, the internal diameter of the already deformed end part increases to separate from the rigid member almost without being raised and increasing the axial extension of the elastically deformable piece; this mostly radial (annular) deformation allows the system not to take up product (or in any case to significantly reduce the uptake of product) when the pressure exerted on the tube ceases, which considerably limits the contamination of the tube; in the prior art, the deformable end-fittings of the dispensing systems generally perform a pivoting movement on being raised to open the orifice (with the base of the pivot which is displaced by also being raised) and a reverse pivoting movement by being folded back on reclosure, such a movement favouring the uptake of product; a difference of the two diameters of between 2 and 6/10^{th} mm can be envisaged;
the straining portion of the rigid member can be disposed peripherally relative to the opening end of said rigid member;
the straining portion of the rigid member can be offset radially relative to the position of the opening end of said rigid member which is centred relative to the opening end part of the elastically deformable piece;
the straining portion of the rigid member can be offset axially (and radially) relative to the axial position of the opening end of the rigid member and set back relative to this position so as to be surrounded by the elastically deformable piece;
the straining portion of the rigid member can surround the opening end of said rigid member; this arrangement makes it possible to uniformly distribute the axial strain exerted by the straining portion of the rigid member on the inside of the elastically deformable piece; preferably, the straining portion of the rigid member has an axial symmetry;
the portion of the rigid member can penetrate into the strain zone according to an axial distance of between 2 and 4/10^{th} mm;
the rigid member can strain the zone of the elastically deformable piece according to a flat contact, in bevel form, in point form, or any other form between the straining portion of the rigid member and the zone of the piece;
the rigid member can penetrate into the zone of the piece according to a contact in bevel form, point form or any other form between the straining portion of the rigid member and the zone of the piece;
the opening end part of the elastically deformable piece bears on the opening end of the rigid member via an edge; the contact on an edge limits the contact surface and therefore any possibilities of the piece sticking to the rigid member after the passage of the product between these elements for its exit from the tube; such is for example the case with an ophthalmological product;
the opening end part of the elastically deformable piece bears on the opening end of the rigid member via a bearing surface; this arrangement can prove useful when the product of the tube is not of the type to stick to the surfaces with time;
the opening end part of the elastically deformable piece deformed according to the first permanent deformation adopts an incurved form whose concavity is oriented towards the outside of the system; the form is for example that of a peripheral edge of a piece which internally delimits an orifice and which is turned up outwards under the action of a member force-fitted into the orifice and which forces the edge to be deformed radially by being incurved outwards like the lips which open;
the opening end part tends, in case of pressure exerted on the jacket of the tube, to separate radially from the opening end of the rigid member by being deformed to adopt a second deformed position, in said second deformed position, the opening end part defining, with the opening end of the rigid member, an orifice through which a drop of product is formed when the product passes through said orifice.

### BRIEF DESCRIPTION OF THE DRAWINGS

Other features and advantages will become apparent from the following description, given purely as a nonlimiting example and with reference to the attached drawings, in which:

FIG. 1 is a general schematic view of a drop dispensing device according to an embodiment of the invention;

FIG. 2 is a view of the device of FIG. 1 without the drop dispensing system;

FIG. 3 is an exploded view of the different elements of the device of FIG. 1 without the tube;

FIG. 4a is an enlarged view of the top part of the device of FIG. 1 without the tube;

FIG. 4b represents the tube of FIG. 1 in turned over position of use for the dispensing of drops of product;

FIGS. 5a and 5b are comparative views of two different configurations of drop dispensing system with (FIG. 5a) and without (FIG. 5b) straining of the elastically deformable part around the rigid member;

FIG. 5c represents another embodiment of the drop dispensing system;

FIGS. 6a and 6b illustrate variant embodiments of drop dispensing system with different ways of producing an axial compression of the elastically deformable piece;

FIGS. 7a and 7b illustrate variant embodiments of drop dispensing system with different contacts on the central part of the rigid member;

FIG. 8 is a schematic view of a drop dispensing system (in turned over position) combining the effect of a needle on a spring with that of an elastically deformable part mounted under strain.

### DETAILED DESCRIPTION

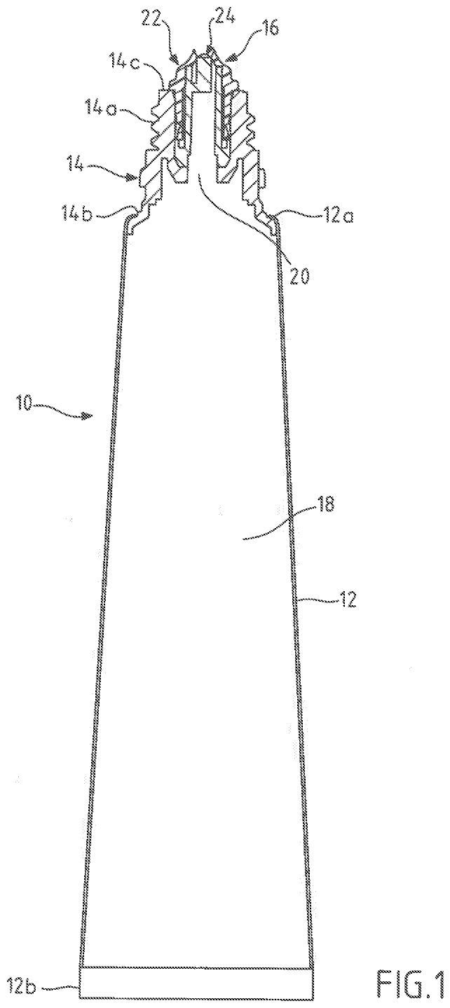

As represented in FIG. 1 and designated by the general reference denoted 10, a device for dispensing drops of a liquid or semi-liquid product according to an embodiment of the invention comprises, on the one hand, a container 12 in the form of a flexible axial tube on which is mounted a neck-forming part 14 and, on the other hand, a system or end-fitting for generating drops 16 disposed at the neck. In this embodiment, the product is liquid and it is for example an ophthalmological product. Alternatively, the product can be, for example, a very fluid cream such as a milk, even a gel.

In FIG. 1, the tube is disposed vertically in storage position with the system 16 positioned at the top of the tube. The tube is a conventional tube available on the market.

More particularly, the tube 12 takes the form of an elastically deformable outer jacket, for example produced in polyethylene or in polypropylene, and defining an internal space 18 which encloses the product to be dispensed (not represented in FIG. 1).

The tube 12 has two opposing ends, namely a top end 12a in FIG. 1 which is provided with a first opening at which the system 16 is fixed and a bottom end 12b which forms a tube bottom. In the manufacturing of the tube, the tube bottom is left open (second opening) to fill the tube with product. Once the product is introduced into the internal space 18 of the tube, the bottom is resealed, for example by performing a welded pinching of the edges of the outer jacket delimiting the second opening.

The neck-forming part 14 is more particularly fixed at the edges of the first opening (the neck-forming part is for example mounted by a force-fitting in the opening, but can alternatively be snap-fitted, screwed, welded, etc.) which defines, in its central portion, a passage 20 for the product to be dispensed. The neck-forming part 14 has, on its outer surface, an outer threading 14a and has a generally substantially cylindrical form which extends axially from a widened base 14b fixed to the jacket of the tube to a top 14c. The central passage 20 extends axially from the base to the top of the neck 14.

The system or end-fitting for generating drops 16 is mounted partly inside the neck 14 and can, on the one hand, form a drop of product and expel it out of the system (when the tube is turned over in position of use) following an external pressure exerted on the outer jacket and which tends to deform it and to reduce the internal volume 18 and, on the other hand, to limit, even prevent, any return of product into the system when the external pressure on the jacket ceases.

The system for generating the drops 16 more particularly comprises an elastically deformable piece 22 and a rigid member 24 which are both mounted inside the neck 14 with the piece 22 generally pierced at its centre, which surrounds the member 24 and is pinched between the internal surface of the neck and the member 24. The piece 22 and the member 24, for the system, form what can be called a valve system.

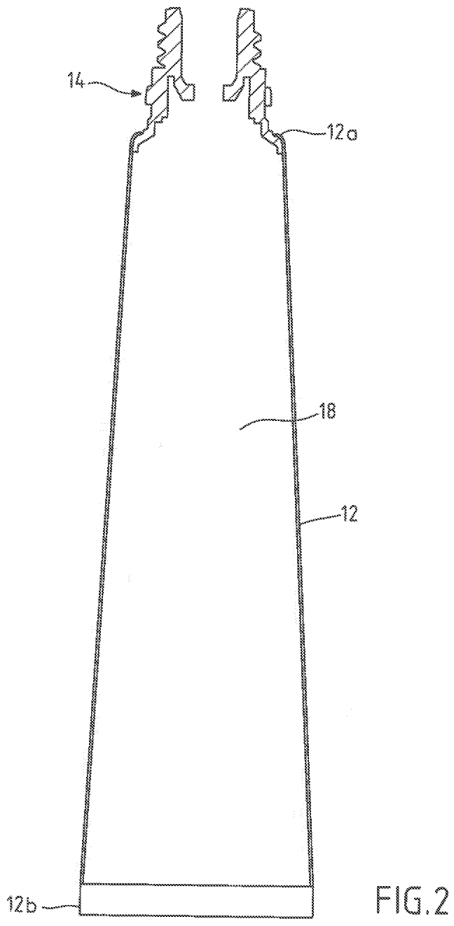

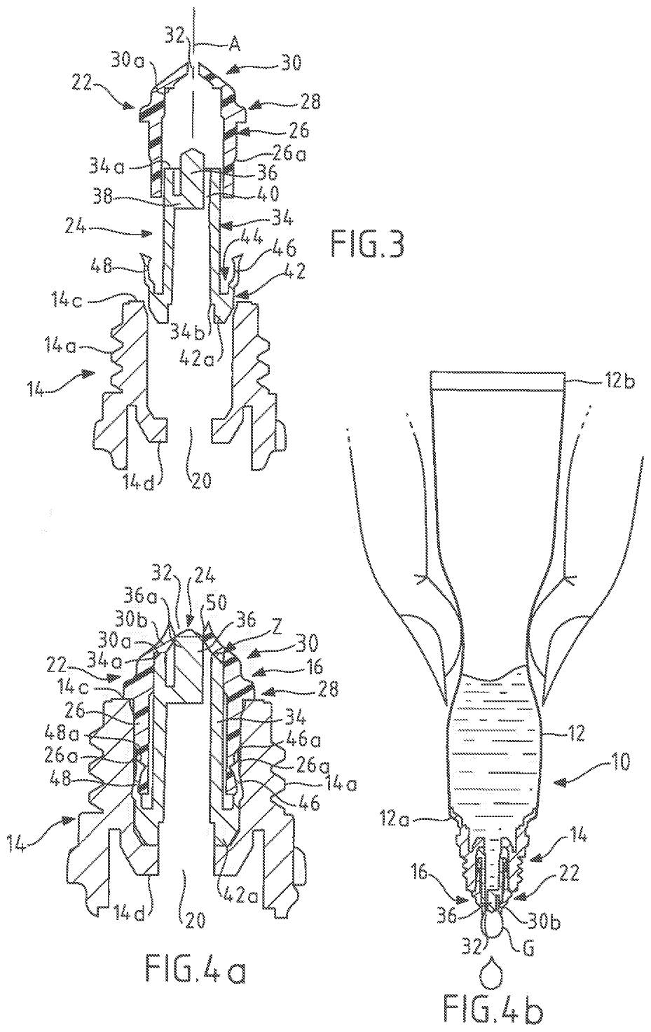

FIG. 2 represents the tube 12 and its neck 14 open without the system 16. FIGS. 3 and 4a illustrate the mounting of the elements 22 and 24 of the system 16 inside the neck 14 (the tube is not represented in the interests of simplification).

This mounting will make it possible to strain the elastically deformable piece 22 inside the neck 14, between the latter and the rigid member 24. It will be noted that the present principle of mounting under strain of an elastically deformable piece of a system for dispensing drops inside the neck of a tube of product and around a rigid member placed in the neck applies to other forms of system, of neck, of elastically deformable piece and of rigid member other than those illustrated in the figures and described here.

FIG. 3 is an exploded view which represents the order of mounting of the different elements of the system for dispensing drops in the neck 14.

As represented in FIG. 3, the neck-forming part 14 comprises an internal portion 14d situated at the bottom of the threaded cylindrical portion 14a, on the inside of the neck and which forms an internal annular rim narrowing the passage 20 for the product. This internal rim 14d serves as axial bearing for the rigid member 24.

The elastically deformable piece or membrane 22 here has a symmetry of revolution on the axis A and is produced in flexible elastic material, of elastomer or rubber type. This piece forms what can be called a shutter.

The piece 22 comprises a lateral skirt of substantially cylindrical of revolution 26 form, for example topped by a thicker portion 28 which extends radially and outwards beyond the diameter of the cylinder 26. The piece 22 also comprises an axial cylindrical portion topping the portion 28 and, beyond this cylindrical portion, a terminal portion 30 which comprises the opening end of the piece and which has substantially a conical form forming an axial orifice 32 at its top. The configuration of the piece 22 can vary notably as regards the skirt 26, the widened portion 28 and the conical form of the terminal portion 30.

The rigid member 24, also called needle, is more rigid than the piece 22 but can however accept certain deformations. The member 24 comprises an internal skirt 34 that is cylindrical of revolution and a central portion 36 situated in the skirt 34 and protruding axially beyond said skirt and away from the tube (through the opening end or point of the central portion). The central portion 36 is connected internally by an internal arm 38 at right angles to the skirt 34, thus leaving free at least a passage orifice 40 (here annular except in its portion where the arm 38 extends) for the product. The central portion 36 has a central position that is axial relative the laterally or radially offset peripheral skirt 34.

In this embodiment, the top end 34a of the skirt is flat and here has an axial symmetry of revolution. This end 34a is intended to come into contact with an internal surface 30a of the conical terminal portion 30 of the piece 22 (and to generate an axial strain or thrust effort on this internal surface to interfere mechanically or not with the latter as will be explained later) which also has an axial symmetry of revolution.

The rigid member 24 also here comprises an outer skirt 42 which surrounds a bottom part of the internal skirt 34 and is linked to the bottom end 34b thereof. The outer skirt 42 extends axially lower than the internal skirt 34 in the form of a terminal portion 42a widened outwards from the rigid member. The internal skirt 34 and the outer skirt 42 together define between them a substantially annular groove 44.

The rigid member 24 comprises, for example, a plurality of radially elastic tabs 46, 48 (there are two in FIG. 3) distributed around the internal skirt 34 according to a symmetry of revolution. The tabs 46, 48 (and those not represented) upwardly extend the outer skirt 42.

The tabs 46, 48 delimit, with the internal skirt 42, a reception space in the groove 44, in which the lateral skirt 26 of the piece 22 is introduced axially as illustrated in FIG. 4 upon the axial insertion of the rigid member 24 inside the neck 14 until the terminal portion 42a comes into axial abutment on the internal brim 14d. Other configurations of mounting of the piece 22 around a rigid member can be envisaged.

The tabs 46, 48 deform radially towards the lateral skirt 26 and come to bear against a peripheral break 26a thereof situated between two cylindrical zones. The free ends 46a, 48a of the tabs have a form suitable for cooperating with the break 26a and, for example, having a bevelled form which closely follows the bevelled form of the break. The tabs 46, 48 are produced in a material that is more rigid than that of the piece 22 and thus penetrate radially into the skirt 26 to exert a radial tightening effort on the piece 22. The widened portion 28 (annular brim) of the piece 22 comes into axial abutment against the free end 14c of the neck 14.

The configuration of the rigid member 24 can vary notably with regard to the internal skirt 34, the central portion 36 and its point, the outer skirt 42 and its tabs. Other forms of member can be envisaged.

In the position of FIG. 4a, a part of the system 16 is situated outside of the neck 14 and protrudes axially with respect to the latter.

When the piece 22 is force-fitted (under strain) inside the neck 14, between the neck and the rigid member 24, the rigid member exerts strains (e.g.: axial, radial) on the piece 22 which induce a first deformation in the terminal portion 30 of said piece. This first deformation is permanent inasmuch as it remains as long as the piece 22 is mounted under strain in the neck with the rigid member 24.

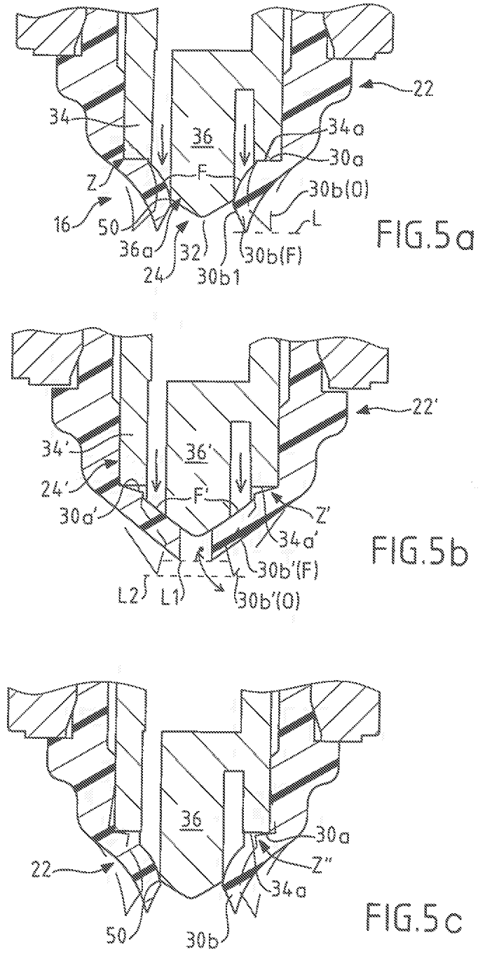

The rigid member 24 comprises a portion 34a (distinct and away from the central portion 36) which exerts an axial strain or axial thrust effort from the inside in a zone Z of the piece 22 (the zone Z is a zone of the internal face of the terminal portion 30 where the reference 30a is situated in FIGS. 3 and 4a). This axial strain (that can be qualified as axial “compression”) is generated permanently at the zone Z when the elastically deformable piece 22 is mounted around the rigid member in the neck and the zone Z of the piece comes to bear on the portion 34a. The zone Z is situated at a distance from the opening end of the piece 22 (it is the unreferenced end of the piece 22 whose outer peripheral edge surrounds/internally delimits the orifice 32) and defines with this end (with the edge delimiting the orifice 32) a part of the piece 22 called opening end part 30b (FIG. 4a). This zone of axial straining thus defines and fixes the point or the zone from which the opening end part 30b can be displaced in a controlled manner. By virtue of this axial strain which blocks the opening end part 30b at the zone Z, said part 30b can subsequently only be deformed by being displaced mostly radially or annularly (and to a very minor extent axially) by moving away from the point of the central portion 36 of the rigid member upon the opening of the system 16 to allow the product to exit. With this axial strain, the flexible piece 22 cannot slide on the rigid member 24 unlike the embodiment of FIG. 5c.

This axial straining arrangement makes it possible to control the zone or part of deformation of the flexible piece and the manner in which the opening end zone or part 30b (this part can be qualified as lip(s)) will be deformed to open an orifice or passage in order to allow the flow of product in the form of a drop when the user presses on the tube.

The axial straining of the piece 22 by a straining portion of the rigid member 24 is ensured in this example by a flat contact between the two elements concerned (e.g.: here, the elements 30a and 34a). It will be noted here that the terminal portion 30 of the piece 22 has, on its internal face, a break or shoulder 30a (here horizontal) which is situated at the base of the overall conical form of said terminal portion and which is at a distance from the opening end of this portion. The break or shoulder 30a is arranged offset radially inwards relative to the axial cylindrical portion topping the overthickness 28. Alternatively, this axial cylindrical portion can be omitted and the seat 30a is then arranged immediately after the overthickness 28, internally thereto. Other configurations of straining portion are however possible as will be seen later.

As represented in FIG. 4a, upon the mounting of the piece 22 in the neck 14 with the member 24, the central portion 36 (which comprises the opening end or terminal part 36a of the rigid member) exerts an axial thrust on the inside of the opening end part 30b, notably at the peripheral edge delimiting the orifice 32 (internal outlet diameter of the opening end part 30b), because of the greater outer diameter of the point 36 (for example a difference of the order of 2 to 6/10^{th} mm between the two diameters is possible). This tends to radially enlarge the orifice 32. The opening end part 30b is thus also deformed radially by its bearing on the outer periphery of the point 36 (it is pushed back by the point 36). This arrangement thus guarantees the seal-tightness of the system with respect to the outside.

The opening end part 30b thus deformed by straining upon the mounting in the neck adopts a generally incurved form whose concavity is turned outwards from the piece 22 (e.g.: turned up edge(s) of the lip or lips delimiting the orifice 32).

The axial straining of the piece 22 by the straining portion of the rigid member at the zone Z has made it possible to define the deformable part or zone of this piece (opening end part 30b) and to control its deformation by prioritizing its radial deformation. This deformable part or zone 30b participates in the control of the dimensions and of the regularity of the drop dispensed, that is to say of the dose of product. This part in some way constitutes a setting zone whose parameters (length, thickness, material, etc.), when selected appropriately, notably make it possible to apportion the pressure effort to be applied on the tube, to control the geometry of the drop, etc..

The axial straining can be obtained by making the straining portion penetrate (mechanical interference) or not into the piece 22. In case of penetration, the distance of penetration or of interference of the penetrating portion in the piece 22 is for example from 2 to 4/10^{th} mm.

The pieces 22 and 24 can have respective Shore hardnesses of 35 to 45 and 60 to 80.

In FIG. 4a (enlarged view of the top end of the device of FIG. 1 without the tube), the opening end part 30b is bearing via a contact edge 50 on the outer periphery of the point 36. Such bearing makes it possible to limit, even completely eliminate, any sticking of the elements in contact by the remainders of product when it is extracted from the system.

In the positions of FIGS. 1 and 4a, no pressure is exerted on the tube to dispense drops of product. It will be noted that, to dispense drops of product, the device 10 must be turned over (head downwards or at least inclined downwards) as represented in FIG. 4b. The user presses on the outer jacket of the tube 12, which provokes the radial separation of the opening end part 30b from the point 36 and the generation of a drop G through the widened orifice 32. More explanations will be supplied below with reference to FIGS. 5a and 5b.

FIGS. 5a and 5b are comparative views, in turned-over position, showing the configuration and the behaviour at the opening of the opening end part according to an embodiment of the invention (FIG. 5a) and of the same elastically deformable piece mounted around the same rigid member but without axial straining upon the mounting inside the neck (FIG. 5b; the peripheral portion 34a′ of the rigid member does not exert axial strain on the internal face of the elastically deformable piece).

In FIG. 5a, the position 30b(F) of the opening end part is that obtained at the end of mounting under strain of the piece 22 around the member 24 in the neck (identical to the position of FIGS. 1 and 4a). This is a first position in which the part 30b has undergone a permanent double deformation as explained above (a first deformation generated at the edge 50 and a second local deformation generated at the axial straining zone Z. It will be noted that this second local deformation can be generated differently and notably by an axial straining by another type of penetrating or non-penetrating rigid member—elastically deformable piece contact. Likewise, the first deformation can be generated differently, notably by another type of bearing between elastically deformable piece and point of the rigid member.

In the position 30b(F) of FIG. 5a, the system is closed and does not allow any drop of product to pass because the user of the device 10 is exerting no pressure on the flexible tube 12.

In FIG. 5a, the position 30b(O) shown in broken lines of the opening end part 30b is that obtained when the user of the device 10 exerts a pressure on the flexible tube 12.

To dispense a drop of product, the user holds the tube between the fingers of one hand and presses on the deformable outer jacket of the tube 12 as illustrated in FIG. 4b. By thus deforming the jacket, the volume of the internal space 18 enclosing the product is reduced, which generates a rise in pressure of the liquid product in the jacket. The pressure of the liquid product inside the tube is thus proportional to the bearing force of the user on the tube. The force exerted by the user is for example between 200 and 500 g.

The liquid product under pressure pushes on the internal face F of the opening end part 30b (see the direction of the vertical arrows in FIG. 5a), thus outwardly, preferably/mostly radially, separating the edge or edges 30b1 of the peripheral wall which delimit the orifice 32. The orifice 32 widens while the opening end part 30b primarily separates radially from the point 36 of the rigid member 24 (to adopt open/separated position shown in broken lines of FIG. 5a), while remaining in the same axial position as testified by the axial position L.

This essentially radial movement/displacement is obtained by virtue of the fact that the opening end part 30b is blocked/limited in its movement by the axial strain exerted by the axial bearing of the zone Z against the portion 34a of the rigid member (in the downward direction in FIG. 5a). To reach the open position (O), the opening end part 30b (this part can be likened to a deformable lip) is therefore deformed elastically preferably/mostly in a radial direction by moving away from the opening end of the rigid member.

In this position 30b(O), the liquid product can flow through the enlarged orifice 32 (outlet for example of cylindrical form).

In FIG. 5b, the same references as in FIG. 5a have been reused with a “′” symbol to distinguish the elements.

According to this unstrained configuration, it can be seen that the part 30b′ is not deformed in its closed position 30b′(F) and rests simply on the rigid member 24′ by bearing, on the one hand, on the end 34a′ of the skirt 34′ via a contact zone Z′ (there is no axial strain exerted between the end 34a′ and the zone Z′) and, on the other hand, on the tapered seat of the point 36′. On opening, the thrust of the product on the internal face F′ of the end part 30b′ provokes the pivoting thereof downwards as indicated by the arrow to the open position shown by broken lines 30b′(O). Since the part 30b′ is not strained at the zone Z′, a conventional pivoting movement is performed (the pivoting point is not blocked at the base of the part 30b′) and the end of the part 30b′ changes axial position between the closed position (axial position L1) and the open position (more extended axial position L2) by also separating radially from the rigid member 36′. The deformation of the part 30b′ is free.

This configuration does not make it possible to control the dimensions and the regularity of the drops formed. Consequently, the dose of product dispensed by such a system is less precise than the system of FIG. 5a, in its form or in its different embodiments and possible variants.

Moreover, the configuration of FIG. 5b is much more subject to product uptake upon the closing of the system (when the pressure on the tube ceases and the part 30b′ is displaced in reverse to return to bear on the rigid member in its initial position) than the configuration of FIG. 5a, as will be explained later.

Returning to the dispensing of drops of product with the configuration of FIG. 5a, it will be noted that, by pressing slowly, constantly with a reasonable pressure (for a user) on the tube, the phenomena of adhesion of the materials in contact with the product (surface tensions) make it possible to keep the product in suspension at the end of the system (valve system) and thus form a drop of product. This drop drops when its weight is greater than the resistance generated by the surface tensions which retain the drop.

The volume of the drop is defined by several parameters including the forms, the dimensions, the surface states, the materials of the system 16 (valve system) and the very construction of the product (viscosity, etc.).

A drop of product thus formed corresponds to a dose of product. The user generates his or her dose since the drops are generated by him or herself whereas, in a device provided with pumping means, it is the pump which manages the dose but it does not manage the drops.

When the user ceases to press on the tube, the pressure of the liquid product in the latter decreases and, by virtue of the elasticity of the constituent material of the piece 22, notably of the opening end part 30b (flexible wall), the part 30b is resealed in a controlled manner around the rigid member 24 (central portion 36) by retightening mostly/preferably radially (annular contraction) and reverts to its initial form, like the orifice 32 (FIGS. 1 and 2), thus preventing any passage of product out of the system 16.

When the opening end part 30b reverts to its initial form, the edge or edges 30b1 of the wall which delimit the orifice 32 (deformable lips) close up and thus separate the drop being formed from the product remaining inside the valve system. The drop thus remains in suspension on the outer end of the system 16 (valve system) in resealed position.

Because of this, the drop is not sucked back into the valve system when the pressure on the tube ceases. This anti-return of product function (anti-pollution) is advantageous since it makes it possible to avoid adding conserving agents (antioxidants, antibacterial agents) to the product to be dispensed, or in any case to limit the addition of such agents.

The anti-uptake or anti-return function is considerably enhanced with the configuration of FIG. 5a. In fact, the annular constriction movement on the reclosing of the system and which switches the opening end part from the position 30b(O) to 30b(F), makes it possible to detach the product which is still adhering to the system (via the surface tension phenomena) most closely to the latter, notably most closely to the central portion 36 (and its terminal part 36a). The (incurved) part 30b shears/detaches the product cleanly, substantially at the edge 50 by being displaced substantially according to a radius (horizontally) and therefore according to a same axial position, without returning product inside the system. On the other hand, in FIG. 5b the upwards pivoting movement of the part 30b′ to switch from the open position 30b′(O) to the closed position 30b′(F) is like the bending movement of a flap which returns, into the system, product that has been in contact with the outside atmosphere and notably with a zone external to the system (and therefore in contact with the outside), namely the conical seat of the point of the central portion 36′. It is notably product which was present at the opening between the internal face F′ and the conical seat of the point of the central portion 36′ when the part 30b′ was in the position 30b′(O).

Once the dispensing of drops has been performed and the system 16 (valve system) according to the invention is reclosed, it is therefore possible to once again use the device (multi-dose device) to dispense one or more drops of product (according to desired dose), immediately after or else later in the same day, after one or more hours, even another day and, for example, repeatedly over time over a predetermined period.

It will be noted that, to generate several drops consecutively, it is possible, either to alternate the pressing and releasing steps on the tube, or to press in a prolonged manner thereon.

FIG. 5c illustrates another embodiment in which the elastically deformable piece 22 is mounted under strain around the rigid member, notably its central portion 36, simply by bearing of the opening end part 30b on the outer periphery (here on an edge 50 but it could be bearing surface) of the point of the central portion 36 of greater diameter as already explained above. By contrast, the peripheral portion 34a (offset radially relative to the central portion or needle 36) of the rigid member does not locally strain the elastically deformable piece as in FIG. 5a. The elastically deformable piece 22 is simply mounted to bear against the portion 34a of the rigid member via the bearing surface 30a (contact zone Z″). Thus, the opening end part 30b is not blocked in its subsequent movement of radial deformation to allow a drop to pass as illustrated by broken lines in FIG. 5c. The opening end part 30b can thus separate from the rigid member (point 36) by sliding over the portion 34a of the rigid member (portion radially and axially separated from the central portion 36) and by performing an uncontrolled movement that is both radial and axial. Such an arrangement can prove useful to have an orifice of enlarged passage and/or to reduce the pressure effort to be exerted on the tube, for example according to the viscosity of the product.

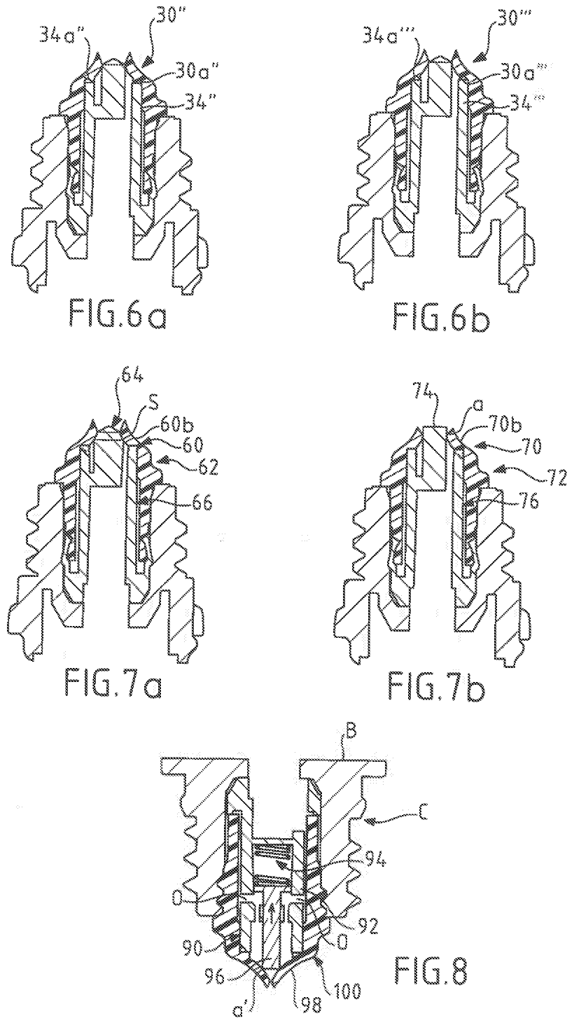

Other embodiments for one or more straining portions (for example, several peripheral portions can be distributed around the central needle) of the rigid member 24 in the elastically deformable piece 22 can be envisaged:
in FIG. 6a, the rigid member penetrates axially into the zone of the elastically deformable piece according to a contact between an off-centre portion (relative to the central portion) in bevel form of the rigid member and the zone of the piece: the top end 34a″ of the skirt 34″ has a recessed bevel form (turned inward) which penetrates axially into an internal zone 30a″ of the terminal portion 30″ in order to generate axial (compression) strains therein.
in FIG. 6b, the rigid member penetrates axially into the zone of the elastically deformable piece according to a contact between an off-centre portion (relative to the central portion) in point form of the member and the zone of the piece: the top end 34a′″ of the skirt 34′″ has a point form turned upwards which penetrates into an internal zone 30a″ of the terminal portion 30″′ in order to generate axial (compression) strains therein.

The two embodiments of FIGS. 6a and 6b make it possible to further anchor a straining portion of the rigid member in the flexible piece, thus obtaining a better immobilization thereof and therefore better control of the deformation thereof. The controlled radial separation of the terminal portion 30″, 30″′ is made more difficult. The seal-tightness between the flexible piece and the opening end of the central portion of the rigid member is thus enhanced. With the arrangement of FIG. 6b, the immobilization is even more marked than with FIG. 6a.

According to variants that are not represented, it will be noted that the axial straining of a straining portion of the rigid member in a peripheral zone of the elastically deformable piece can be produced by fitting a particular form of the straining portion in a complementary form of the peripheral zone of the piece. Thus, the straining portion can have a bevel, point or other form and the internal face of the peripheral zone of the piece has a complementary form in order to allow the fitting.

FIGS. 7a and 7b illustrate variant embodiments of contact between the opening end part of the elastically deformable piece and the opening end of the rigid member.

In FIG. 7a, the opening end part 60b of the terminal portion 60 of the elastically deformable piece 62 bears on the opening end 64 (point) of the rigid member 64 via a bearing surface S and not an edge.

In FIG. 7b, the opening end part 70b of the terminal portion 70 of the elastically deformable piece 72 bears on the opening end 74 of the rigid member 76 via a contact edge a. The form of the opening end 74 of the rigid member is rectilinear and not in point form as in FIG. 4a.

In this configuration, the opening end of the rigid member penetrates further axially into the deformable piece, which allows the latter (more particularly, its opening end part 70b) to bear on the outer diameter of the opening end 74. This configuration can, in certain circumstances, have an effect on the drops (e.g.: form, etc.) and notably constitute an additional setting means.

FIG. 8 illustrates another embodiment (here, the dispensing system is directed downwards in dispensing position) in which the rigid member is different from that of FIG. 4a. The rigid member 90 still comprises an axial skirt 92 which, here, is pierced with lateral openings O for the passage of the product. The skirt 92 encloses, in its part closest to the base B of the neck C, an elastic element such as a spring 94. The rigid member 90 comprises a needle 96 mounted axially to slide on the spring (like a piston), inside the skirt 92.

The opening end part 98 of the elastically deformable piece 100 is strained as explained above and bears on the peripheral edge of the needle 96 via a contact edge a′.

When the user presses on the tube, the product descends to the dispensing system of FIG. 8 and causes the needle 96 to rise as indicated by the vertical arrow, while the opening end part 98 (lips) separates radially from the needle as explained above.

The two effects combined (retraction of the needle and deformation of the opening end part 98) make it possible to perform a finer setting of the dispensing of drops by acting, not only, on the opening end part 98 (material, dimensions, etc.), but also on the features of the elastic element 94.

It will also be noted that in the filling of the tube, the product is introduced into the internal space 18 of the tube by leaving a predetermined free volume unoccupied by the product. This predetermined free volume is greater than the volume of product contained in the zone of the device which is undeformable. The predetermined volume to beleft free of product depends on the volume of the undeformable zone. This zone corresponds to the zone of the tube (generally situated at the top end 12a of the tube and below the base 14b of the neck 14) in which the remaining product remains trapped at the end of use of the device because of the undeformable aspect of the device in this zone. The predetermined free volume is thus occupied by a gas such as air (even an inert gas such as nitrogen) which, under the effect of the pressure exerted by the user on the outer jacket of the tube, drives the product accumulated in this zone to the passage 20. This system improves the rate of return of the device. As an example, a predetermined volume of air of approximately a third of the volume of the internal space 18 of the tube is left.

When an embodiment is represented in an embodiment described above with a type of bearing of the opening end part on the opening end of the rigid member and with a type of axial strain (the strain is exerted by a portion of given configuration of the rigid member which enters into contact with the elastically deformable piece), it should be noted that different other types of bearing and/or of axial strain can be used.

As an example, the types of axial strain of FIGS. 6a and 6b can be used instead of the type of axial strain of FIGS. 7a and 7b. Likewise, the bearings of FIGS. 7a and 7b can be used instead of the bearings of FIGS. 1 to 5c.

It will be noted that the device 10 of FIGS. 1 and 4b do not include pumping means, notably no pumping means comprising a thruster mounted on a dosing pump, making it possible to raise the product to the top of the device for it to be dispensed. With such a pumping means, the user does not manage the dose of product dispensed because the latter is imposed by the pump. The device 10 according to the embodiment of the invention is therefore simpler to design than a device which required such a pumping means.

1. Device for dispensing drops of a liquid or semi-liquid product, wherein said device comprises:
an axial tube which comprises an elastically deformable outer jacket defining an internal space enclosing the product,
a neck-forming part which defines an open internal passage for the passage of the product,
a system for generating drops which is disposed at the neck and which can, on the one hand, form and expel a drop of product from the system following a pressure exerted on the outer jacket tending to deform it and to reduce the volume of internal space and, on the other hand, prevent or limit the return of product into the system when the pressure on the jacket ceases, the drop generating system comprising an elastically deformable piece mounted inside the neck of the tube around a rigid member, the elastically deformable piece comprising an opening end part situated outside of the neck and through which the product can exit from the system in case of pressure on the outer jacket, the opening end part of the elastically deformable piece being deformed in a first position following the penetration of an opening end of the rigid member into said opening end part when no pressure is exerted on the jacket of the tube, the rigid member also comprising a portion which exerts an axial strain on a zone of the elastically deformable piece situated at a distance from the opening end of said piece so as to define a pivot point for the opening end part of said piece which is situated between this zone and the opening end of said piece.

2. Device according to claim 1, wherein the opening end of the rigid member has an outer diameter greater than the output diameter of the opening end part, in the absence of deformation, in order for the opening end of said rigid member to radially deform the opening end part when the latter is mounted bearing on the opening end of the rigid member.

3. Device according to claim 1, wherein the opening end part of the deformed elastically deformable piece bears on the opening end of the rigid member via an edge.

4. Device according to claim 1, wherein the opening end part of the deformed elastically deformable piece bears on the opening end of the rigid member via a bearing surface(s).

5. Device according to claim 1, wherein the portion of the rigid member penetrates into the zone according to an axial distance of between 2 and 4/10^{th} mm.

6. Device according to claim 1, wherein the rigid member can strain the zone of the elastically deformable piece according to a flat contact, in bevel form or in point form between the straining portion of the rigid member and the zone of the piece.

7. Device according to claim 1, wherein the rigid member can penetrate into the zone of the elastically deformable piece according to a contact in bevel form or in point form between the straining portion of the rigid member and the zone of the piece.

8. Device according to claim 1, wherein the straining portion of the rigid member is disposed peripherally relative to the opening end of said rigid member.

9. Device according to claim 1, wherein the straining portion of the rigid member is offset radially relative to the position of the opening end of said rigid member which is centred relative to the opening end part of the elastically deformable piece.

10. Device according to claim 1, wherein the straining portion of the rigid member is offset axially relative to the axial position of the opening end of the rigid member and set back relative to this position so as to be surrounded by the elastically deformable piece.

11. Device according to claim 1, wherein the straining portion of the rigid member surrounds the opening end of said rigid member.

12. Device according to claim 1, wherein the opening end part of the deformed elastically deformable piece adopts an incurved form whose concavity is oriented towards the outside of the system.

13. Device according to claim 1, wherein the opening end part tends, in case of pressure exerted on the jacket of the tube, to separate radially from the opening end of the rigid member by being deformed to adopt a deformed second position, in said second deformed position, the opening end part defining, with the opening end of the rigid member, an orifice through which a drop of product is formed when the product passes through said orifice.
